(19) United States
(12) Patent Application Publication
(10) Pub. No.: US 2003/0164257 A1
(43) Pub. Date: Sep. 4, 2003

(54) Wide motorcycle swing arm assembly

(76) Inventor: William Soileau, Katy, TX (US)

Correspondence Address: Craig E. Bohn, River Oaks Tower, Suite 1200, 3730 Kirby Dr., Houston, TX, 77098, US

(21) Appl. No.: 10/378,239

(22) Filed: Mar. 3, 2003

Related U.S. Application Data
(60) Provisional application No. 60/361,567, filed on Mar. 2, 2002.

(51) Int. Cl. B62M 7/00

(52) U.S. Cl. 180/227

(57) ABSTRACT

The swing arm of the current invention is a retrofit assembly for a motorcycle frame configured as in a Harley-Davidson Softail™ motorcycle, allowing for the installation of a wide rear wheel, having a replacement swing arm assembly 10 that mounts to the outside 42 of a stock frame 20. The replacement swing arm assembly 10 has two swing arms 12 positioned in parallel and joined at one end by a spanning bar 14 attached to each swing arm 12 a distance below frame pivot bolt 24. The other end of each swing arm 12 attaches to an axle 34 on opposites side of a tire 30. Existing horizontal shock 17 system attaches to the swing arm assembly 10 through spanning bar 14. The swing arm assembly 10 installs with minor modifications to a stock frame 20. Additional room for the tire 30 and its operation is achieved by moving attachment of the swing arm assembly 10 outside 42 the frame 20. Even wider tires 30 may be accommodated by either or both moving the path of the belt 18 outside 42 the frame 20 or by flaring the swing arms 12 away from the centerline 3 of the motorcycle 1. Either configuration maintains the integrity of the frame 20 and horizontal shock 17 system.

### CROSS-REFERENCE TO RELATED APPLICATIONS

This application claims the benefit of U.S. Provisional Application No. 60/361,567, filed Mar. 2, 2002.

### STATEMENT REGARDING FEDERALLY SPONSORED RESEARCH OR DEVELOPMENT

Not Applicable.

### BACKGROUND OF THE INVENTION

1. Field of Invention

This invention relates generally to kits and components thereof for retrofitting motorcycle factory frames with wide rear tires. Specifically, this invention relates to such kits and components for retrofitting such frames configured as in a Harley-Davidson Softail™ to allow for true center mounting of a wide rear tire.

2. Related Art

It is known in the art that wider rear tires can be installed by modifying a rear swing arm for a motorcycle's rear wheel. Manufacturers typically use a swing arm structure that fits between the stock frames then spreads outward from that point back to accommodate the wider tire. The width of tire that can be installed is influenced by the width of the frame since components fit between the tire and the frame. After-market modifications are often done to inexact specifications and do not typically compensate for misalignment of the rear wheel and tire caused by inherent offset, thereby creating safety hazards.

The Desrosiers U.S. Pat. No. 5,996,718 patent discloses a swing arm for customizing the rear wheel of a motorcycle using a triangular shaped swing arm typical to Harley-Davidson Softail™ motorcycles. The swing arm side plate is moved away from the frame side plate, so the drive belt can be positioned between the two. The Smith U.S. Pat. No. 6,098,736 patent also discloses a similar swing arm assembly.

The Soileau U.S. Pat. No. 6,230,837 patent discloses a single piece swing arm that compensates for a wider tire in order to achieve a true centerline configuration in a motorcycle configured like a Harley-Davidson Sportster™.

It would therefore be a new and useful improvement over prior art for an after-market modification kit to include both a wider rear swing arm for the rear wheel configured for use on a standard Softail™ frame and suspension system, and mounting outside the frame, thereby reducing the width constraints of a standard frame.

### BRIEF SUMMARY OF THE INVENTION

My invention is a retrofit swing arm assembly for a motorcycle frame configured with a horizontal suspension system, as in a Harley-Davidson Softail™ motorcycle. By mounting on the outside of a frame structure a swing arm allows the mounting of a much wider tire with minimal modifications to the frame. With a flared embodiment of the current invention, mounting an even wider tire is possible.

Accordingly, objects of my invention are to provide, inter alia, a retrofit swing arm assembly that:

minimizes the structure between the rear frame side arms;

supports a tire wider than a stock tire; and

able to support a tire wider than a stock motorcycle frame.

Other objects of my invention will become evident throughout the reading of this application.

### BRIEF DESCRIPTION OF THE DRAWINGS

FIG. 1 is a side view of a motorcycle having a rear wheel suspension system using a swing arm of the prior art.

FIG. 2 is a partial top view of a motorcycle having a swing arm of the prior art.

FIG. 3 is a partial top view of a motorcycle having a modified swing arm of the prior art.

FIG. 4 is a partial top view of a motorcycle having an embodiment of the swing arm of the current invention.

FIG. 5 is a partial top view of a motorcycle having an alternate embodiment of the swing arm of the current invention.

FIG. 6 is a partial top view of a motorcycle having another alternate embodiment of the swing arm of the current invention.

FIG. 7 is a partial left side view of a motorcycle frame for attachment of a swing arm assembly and rear wheel.

FIG. 8 is a top view of the partial motorcycle frame shown in FIG. 7.

FIG. 9 is a front view of a prior art original swing arm.

FIG. 10 is a top view of the swing arm in FIG. 9.

FIG. 11 is a left side view of the swing arm in FIG. 9.

FIG. 12 is a front view of a prior art modified swing arm.

FIG. 13 is a top view of the swing arm in FIG. 12.

FIG. 14 is a left side view of the swing arm in FIG. 12.

FIG. 15 is a perspective frontal view of an embodiment of the current invention.

FIG. 16 is a top view of the swing arm embodiment of FIG. 15.

FIG. 15A is a perspective frontal view of an alternate embodiment of the current invention.

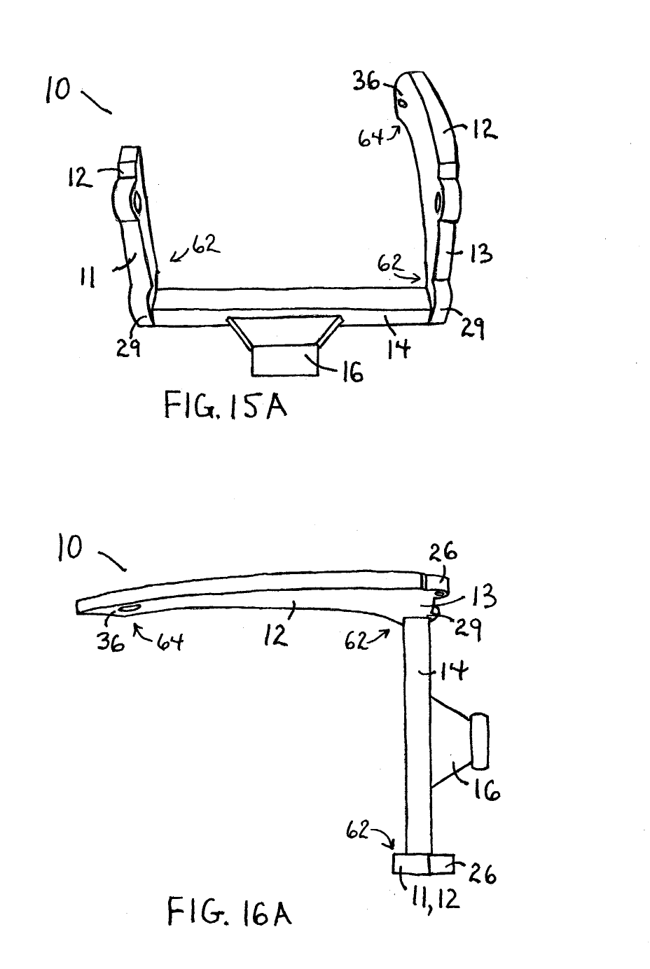

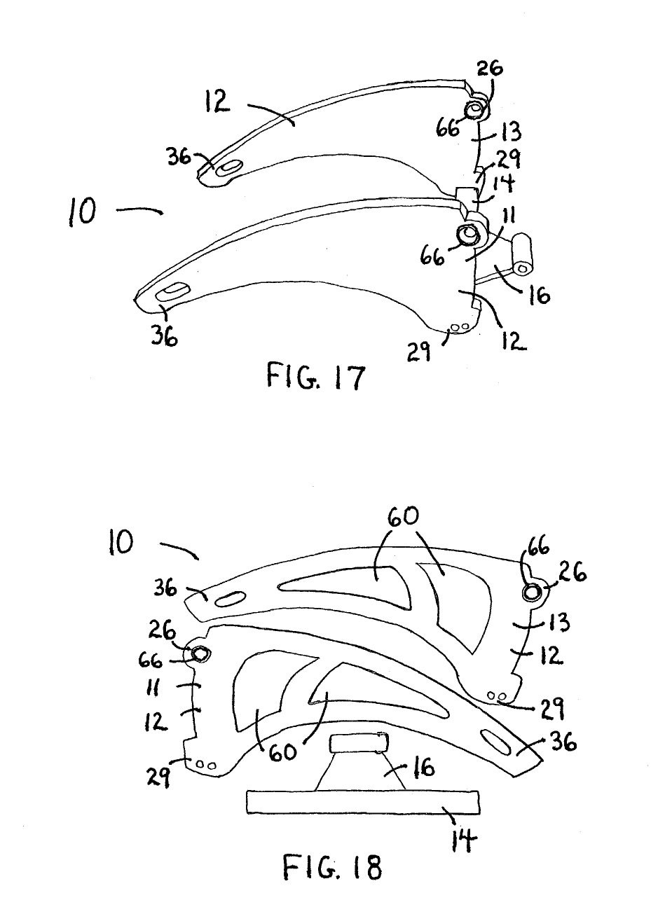

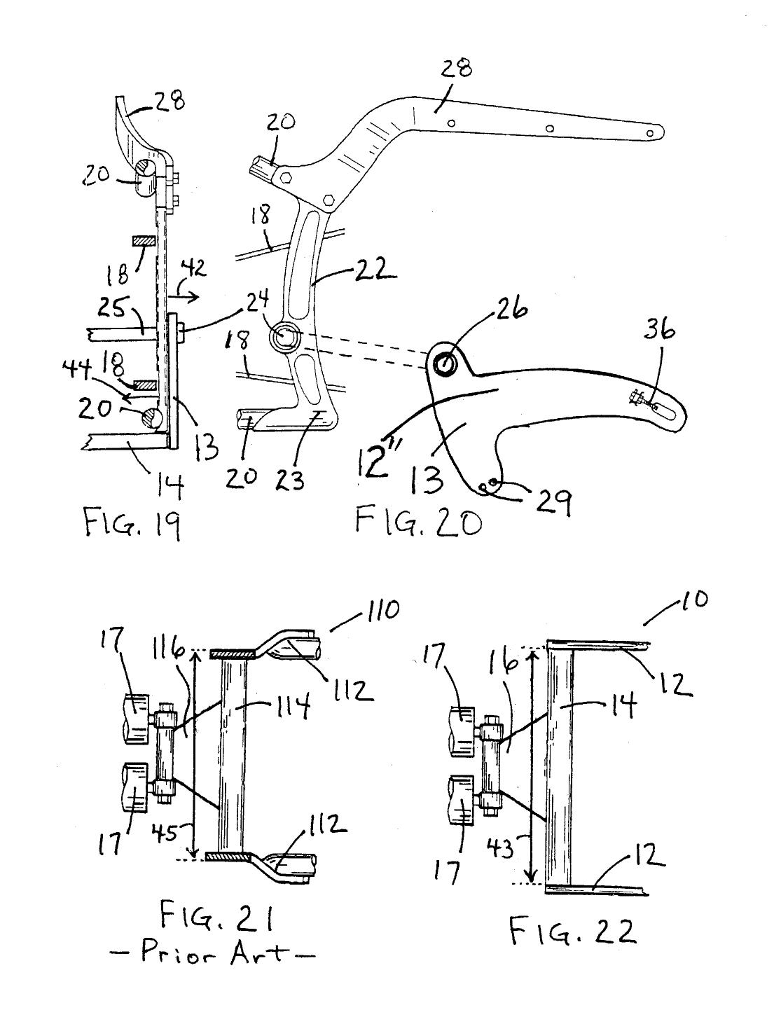

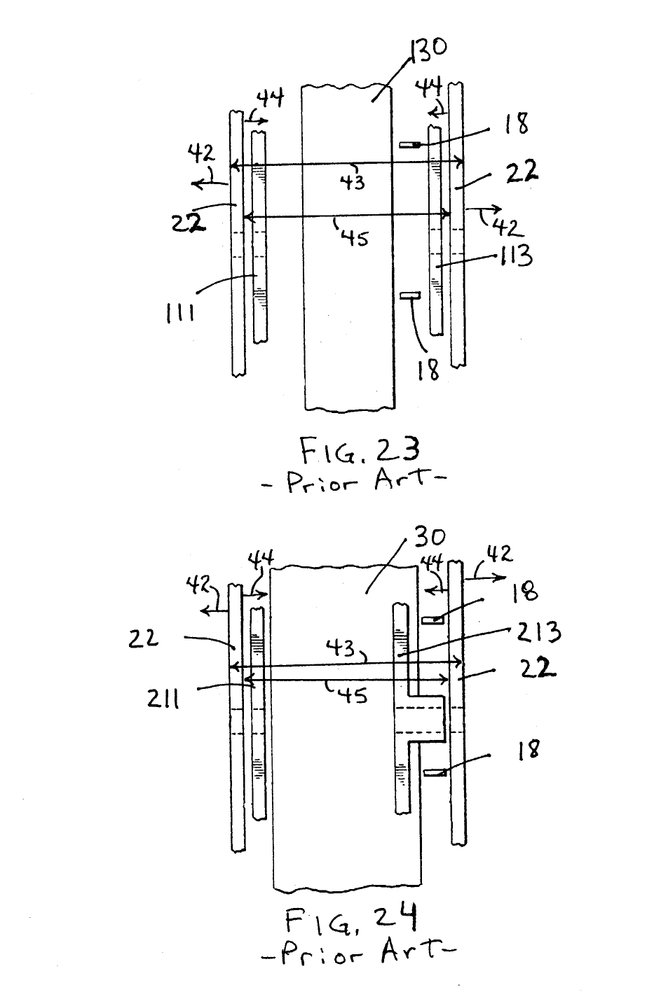

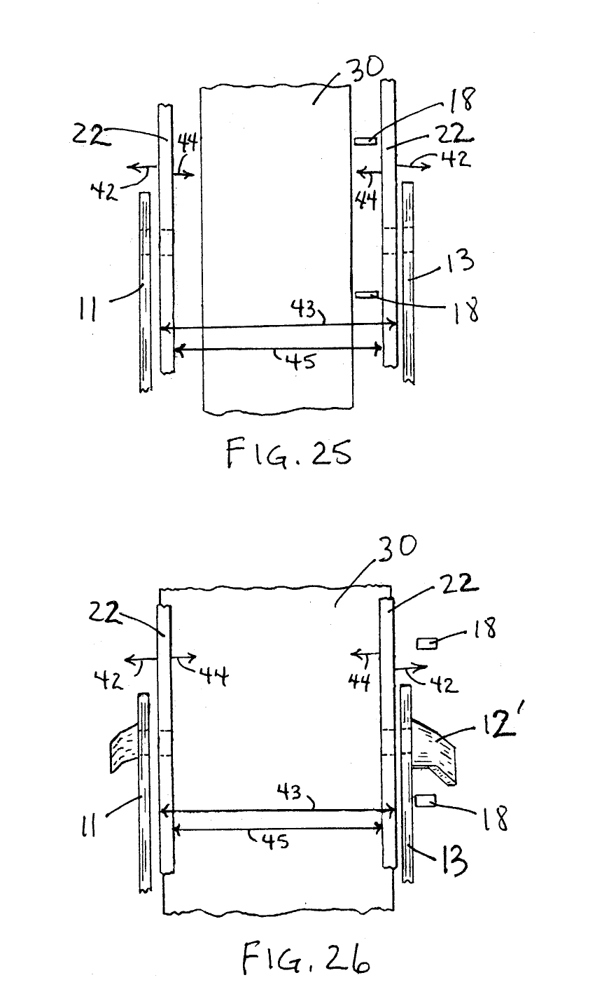

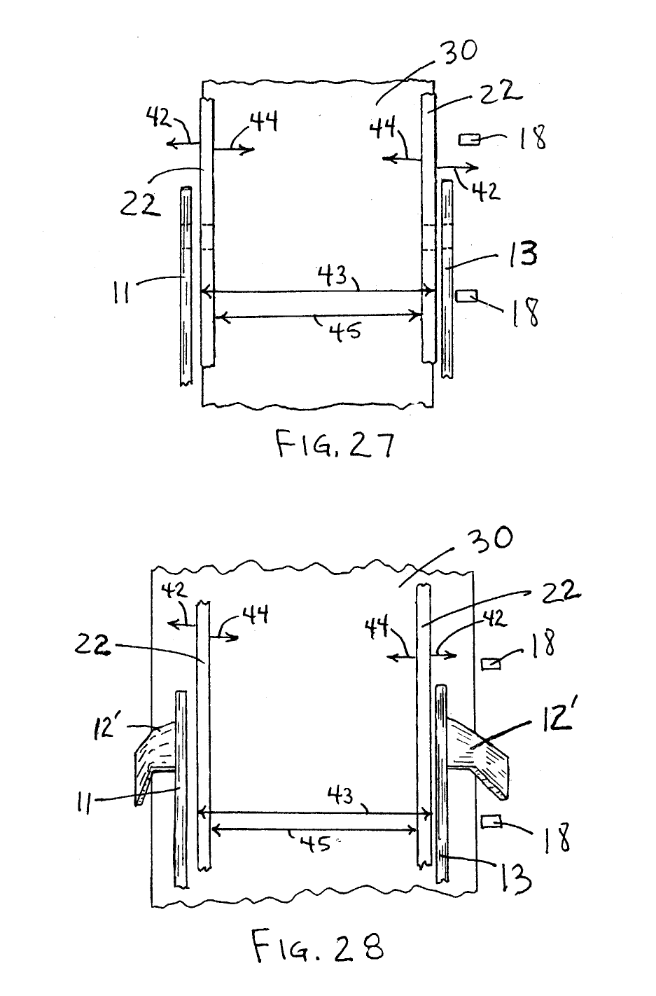

FIG. 16A is a top view of the swing arm embodiment of FIG. 15A.

FIG. 17 is a right side view of the swing arm embodiment of FIG. 15.

FIG. 18 is a view of a modified embodiment of a disassembled swing arm.

FIG. 19 is a partial frontal view of a motorcycle frame with an attached embodiment of a swing arm assembly.

FIG. 20 is an exploded left side view of the frame and swing arm of FIG. 19.

FIG. 21 is a partial top view of an attachment of the shock absorbers to the swing arm of the prior art.

FIG. 22 is a partial top view of an attachment of the shock absorbers to the current swing arm.

FIG. 23 is a partial front view of the embodiment of FIG. 2, cut along line 23-23.

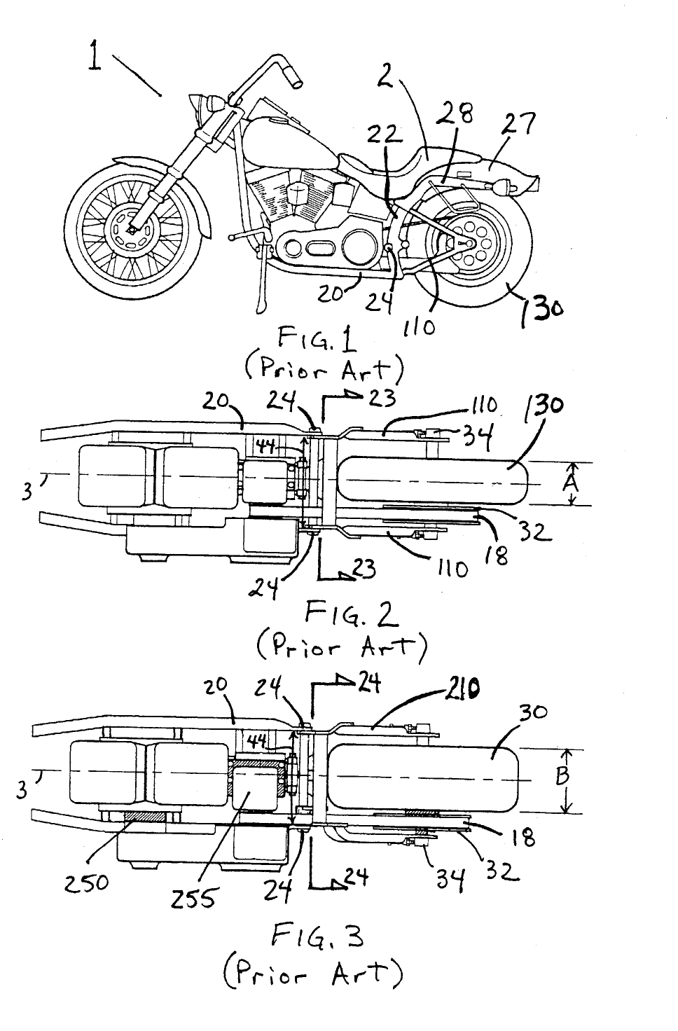

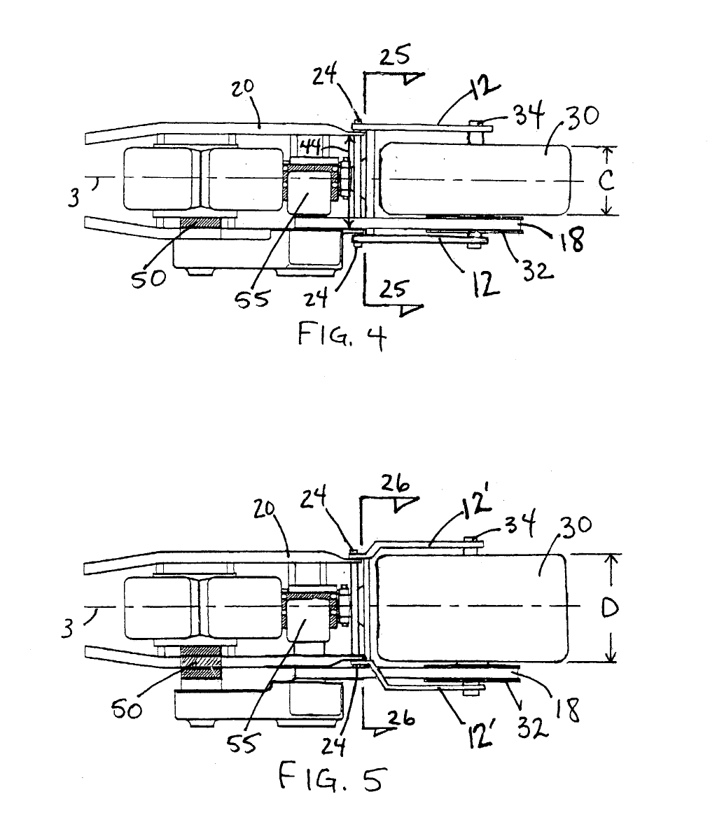

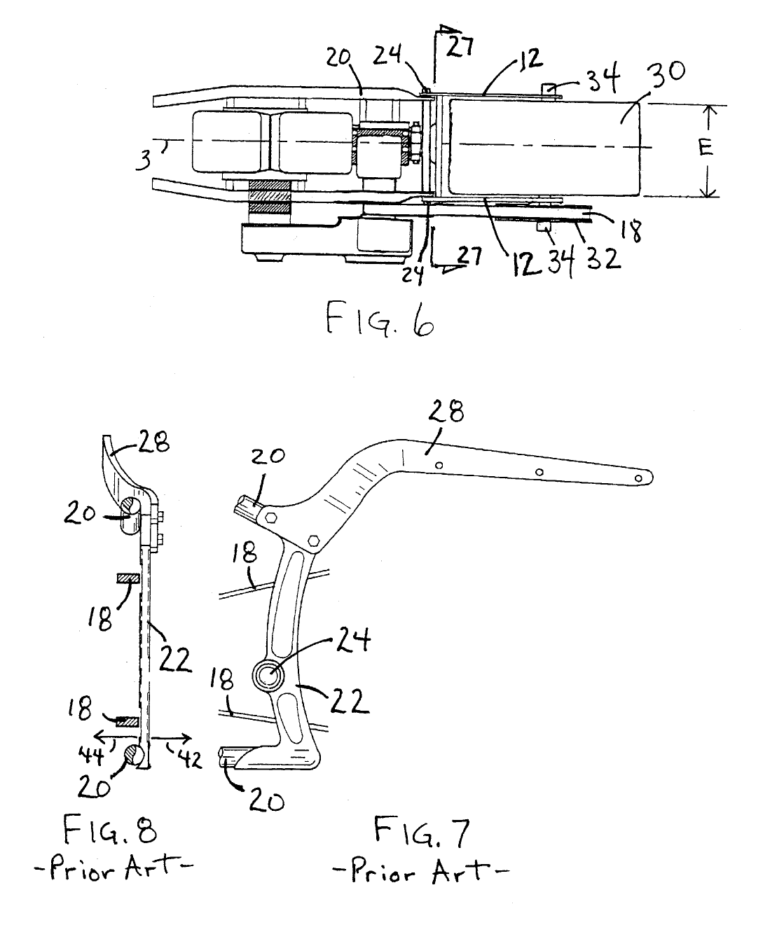

FIG. 24 is a partial front view of the embodiment of FIG. 3, cut along line 24-24.

FIG. 25 is a partial front view of the embodiment of FIG. 4, cut along line 25-25.

FIG. 26 is a partial front view of the embodiment of FIG. 5, cut along line 26-26.

FIG. 27 is a partial front view of the embodiment of FIG. 6, cut along line 27-27.

FIG. 28 is a view with similar perspective as FIGS. 23 through 27, of an alternate embodiment accommodating an extremely oversized tire.

### DESCRIPTION OF THE INVENTION

The wide motorcycle swing arm assembly 10 of this invention is shown in various embodiments in FIGS. 4, 5, 6, 15, 16, 17 and 20. Swing arm assembly 10 replaces prior art stock swing arm assembly 110, or a prior art modified swing arm assembly 210, shown in FIGS. 1, 2 and 3. Swing arm assembly 10 requires a longer frame pivot bolt 24 to span the greater distance of the width of frame 20 plus the thickness of either or both swing arms 12 and 12′. Similar reference numbers represent similar components on differing embodiments.

Referring to FIGS. 1, 7, 8, 19 and 20, motorcycle frame 20 ends below seat 2 of motorcycle 1. Rear frame side arms 22, one on the left and one on the right, define the rear most part of frame 20, onto which any of swing arm assemblies 10, 110 or 210 may attach. Rear fender frame mount 28 secures to frame 20 at the top of frame side arm 22. The inventive swing arm assembly 10, as shown by exemplary left swing arm 13, attaches with frame pivot bolt 24 outside 42 of frame 20 at axis hole 26. In an alternate embodiment (not shown) frame pivot bolt 24 may comprise two shorter components which each secure an individual swing arm 26.

Referring to FIGS. 1, 17, 18 and 20, the exemplary embodiment swing arm 12″ illustrates that the invention is not limited to the specific cosmetic shapes shown for side swing arms 12. By using machined steel, aluminum, metallic alloy, polymer, composites or other material with similar suitable physical properties and characteristics the specific design can be stylistic. The key components are the points of interface with the stock components of motorcycle 1, and the strength and durability to withstand the stresses of being part of frame 20 and maintain a straight centerline 3.

Referring to FIGS. 1, 2 and 3, stock swing arm assembly 110 is original manufacturer equipment and allows for a stock tire 130 of standard width A. This application refers to frames configured as original equipment frames as being “standard”. Various forms of modified swing arm assemblies 210 are available from after-market suppliers and permit the installation of wider tires 30, where width B is greater than width A. Both of these prior art configurations mount inside 44 rear frame 20 to rear frame side arms 22 with rear frame pivot bolt 24. Drive belt 18, or chain, as it may be, is also positioned inside frame 20. These additional components, being inside rear frame 20, limit width B.

FIGS. 9, 10, 11 and 23 show how the stock swing arm assembly 110 is configured for belt-side plate 113 and off-belt plate 111 to fasten to the inside 44 of side arm 22 of frame 20, shown in FIG. 8. The two frame side arms 22 are set apart a distance 45, which does not change without more extensive modifications to frame 20. Tire 130, belt 18 and swing arm plates 113 and 111 share the limited space. A outside span from outside 42 of frame 20 on one side to outside 42 frame 20 on the other side will always be greater than the inside distance 45 between rear frame side arms 22.

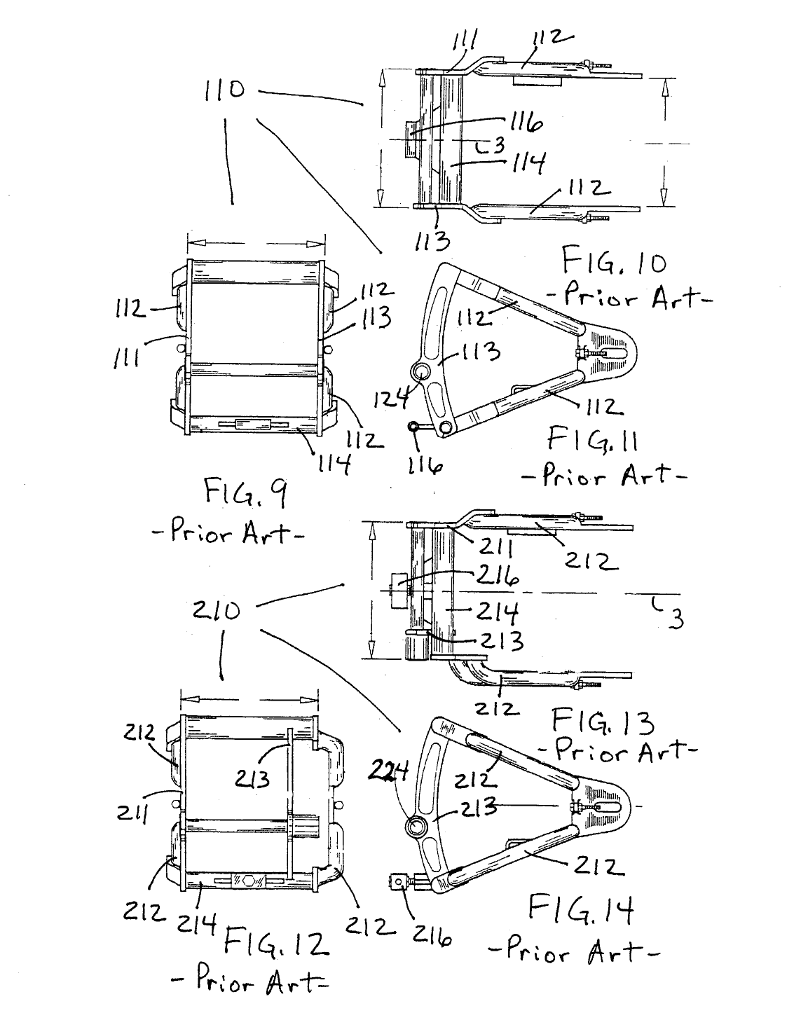

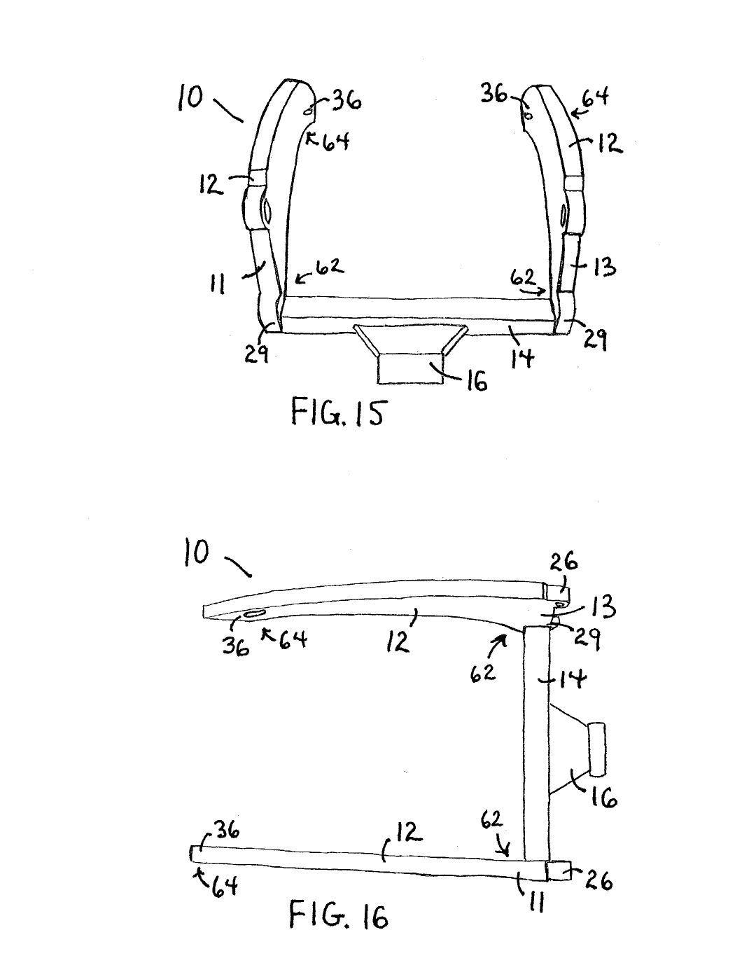

Referring to FIGS. 12, 13, 14 and 24, modified swing arm assembly 210 solves part of the problem by shifting belt-side plate 213 toward the center of tire 30, as a separate component to side swing arm 212. This permits belt 18 to be run closer to frame side arm 22. Tire 30 can therefore occupy the space surrendered by belt-side plate 213.

Referring to FIGS. 4, 5, 6, 15 through 20, and 25 through 28, swing arm assembly 10 mounts outside 42 rear frame 20 with rear frame pivot bolt 24. This takes swing arms 12 outside 42 frame 20, creating additional space for tire 30, even though rear frame side arms 22 may remain the same distance 45 apart. Swing arms 12 start outside distance 43 apart at rear frame side arms 22. Width C is potentially greater than width B. Width C is still limited by the width of belt 18 running inside 44 frame 20.

FIGS. 5, 26 and 28 show exemplary swing arm 12′. Alternate embodiment side swing arm 12′ is similar to swing arm 12, in that it attaches to rear frame 20 with rear frame pivot bolt 24 outside 42 frame side arms 22. The difference is that side swing arm 12′ flares outwardly from its mounting separation distance 43 outside 42 frame side arms 22, to a wide place of securement to rear axle 34. The flare, seen distinctly in FIG. 5 where 12′ crosses belt 18, provides more room for belt 18 to be run outside 42 frame 20.

FIGS. 6 and 27 show exemplary side swing arm 12 running intermediate drive belt 18 and tire 30. Exemplary swing arm 12 connects to rear axle 34 between wheel sprocket 32 and tire 30. Side swing arm 12′ may also be configured in this manner between wheel sprocket 32 and tire 30. With side swing arm 12 or 12′ attached to rear axle 34 between wheel sprocket 32 and tire 30, widths D and E, respectively, may both be greater than width C, and extend past the width of frame side arms 22.

Referring to FIGS. 26 and 28, an embodiment of flared exemplary side swing arm 12′ is shown routed between upper and lower segments of belt 18. Swing arm 12′ may be routed past belt 18 in many manners, as long as consideration is made to protect belt 18 during operation. An exterior belt shroud (not shown), known to the art, may be configured to protect belt 18.

The movement of side swing arm 12 with belt-side plate 13 to the outside 42 of frame side arm 22 makes necessary room in the embodiment of FIG. 25 to accommodate wide tire 30. Swing arms start at outside distance 43 apart, which is already greater than prior art swings arms, which start an inside distance 45 apart. Balance and centering of tire 30 can be achieved without moving the other side swing arm 12 with off-belt plate 11 to the outside 42 of frame side arm 22. In the exemplary embodiments, both swing arms 12 with side plates 11 and 13 are moved to the outside 42 of frame side arm 22 for symmetry, but an embodiment having a swing arm assembly 10 with belt-side plate 13 mounted outside 42 one frame side arm 22 and off-belt plate mounted inside the other frame side arm 22 will function.

Modification of drive shaft 50 and transmission 55 are known in the field and shown as prior art in FIG. 3 as modified drive shaft 250 and modified transmission 255. Referring to FIGS. 4, 5, 6 and 20, axle 34 may be secured to swing arm assembly using methods known to the industry, such as rear axle attachment 36.

Referring to FIGS. 15 through 22, the basic structure of swing arm assembly 10 consists of two side swing arms 12, pivot bar 25, spanning bar 14 and shock interface 16. Swing arm assembly 10 can be a single casting or made up of multiple parts, held together by fasteners or welded. Side swing arm 12 on the belt side attaches to frame side arm 22 at belt-side plate 13, aligning pivot hole 26 with pivot bolt 24. Side swing arm 12 opposite the belt side attaches to frame side arm 22 at off-belt plate 11. Exemplary side swing arms 12 each have both a frame end 62 and an axle end 64, and when mounted to frame 20 extend rearward from frame side arms 22 to axle 34. Rear wheel 30 is secured to swing arm assembly 10 by standard means known to the industry, such as rear axle attachment 36.

Pivot hole 26 houses a pivotable socket 66, which permits a secure precise fit to pivot bolt 24, while allowing adjustments in the alignment of pivot holes 26. Pivotable sockets 66 are secured in a machined against a shoulder (not shown) within pivot hole 26 and a snap ring (not shown) seated into a groove machined within pivot hole 26.

FIGS. 15A and 16A show an alternate exemplary embodiment where only one swing arm 12 has both a frame end 62 and an axle end 64. In this exemplary embodiment care is taken to ensure swing arm assembly is sufficiently sturdy to support the stresses of supporting the entire drive tire 30.

Swing arm pivot bar 25 spans the space between left and right frame side arms 22, securing swing arm assembly 10 to frame 20. Spanning bar 14 spans the distance between the two side swing arms 12, which is approximately the outside span 43 of rear frame side arms 22. Attached to spanning bar 14 is shock interface 16, which connects to shocks 17 in a similar manner as prior art stock swing arm assembly 110, shown in FIGS. 9, 10, 11 and 21. Swing arm assembly 10 maintains a similar function of the horizontal shock 17 suspension system as the prior art configuration, shown in FIG. 21.

Referring to FIG. 19 and 20, exemplary embodiment swing arm 12″ extends below frame side arm lower corner 23. In this embodiment, spanning bar 14 clears below lower corner 23 when fastened to swing arm 12″ through fastener holes 29 with fasteners (not shown). For greater ground clearance, lower corner 23 may be notched, ground or cut down (not shown) to allow belt side plate 13 to be shorter and spanning bar 14 to nest up into the frame side arm 22. The bottom of swing arm 12 may be as high as the bottom of frame 20.

FIG. 18 shows swing arm assembly 10 disassembled. In this configuration, swing arm assembly 10 may be easily packaged for shipment. Exemplary swing arms 12 have sections removed to form cut-outs 60. Cut-outs 60 provide an appealing appearance and reduce the weight of swing arms 12.

It is further recommended that the rear fender 27 be adapted for the wider rear wheel 30. This procedure requires modification of the rear fender frame mount 28. This modification is not shown as part of this invention because it is part of the prior art known to those having ordinary skill in the art of motorcycle retrofitting.

Referring to FIGS. 1, 2 and 21, in preparation to install wide motorcycle swing arm assembly 10, one must remove the existing swing arm assembly 110. Swing arm assembly 110 removal is simpler if tire 130 and axle 34 are removed first. Then, swing arm assembly 110 is accomplished by disconnecting horizontal shocks 17 from shock interface 116 and removing frame pivot bolt 24.

Installation of the replacement swing arm assembly 10 is basically the reverse of the removal process. Referring to FIGS. 4, 5, 6 and 20, swing arms 12 or 12′ are aligned with axis hole 26 to receive frame pivot bolt 24 for attachment to frame 20. With swing arms 12 or 12′ in place, shock interface 16 may be attached to horizontal shocks 17. Axle 34 and tire 30 may then be attached to swing arm assembly 11 while coordinating the positioning of belt 18 on wheel sprocket 32.

The foregoing disclosure and description of the invention is illustrative and explanatory thereof. Various changes in the details of the illustrated construction may be made within the scope of the appended claims without departing from the spirit of the invention. The present invention should only be limited by the following claims and their legal equivalents.

I claim:

1. A wide swing arm assembly for a motorcycle frame having a horizontal suspension system, a frame pivot axis and a frame outside, said swing arm assembly comprising:
a first swing arm, a second swing arm, a spanning bar and a frame pivot bolt;
each said swing arm having a frame end;
at least one said swing arm having an axle end;
said first swing arm and said second swing arm each having an axis hole and a spanning bar attachment point at said frame end;
said spanning bar having a first end and a second end;
said spanning bar said first end attached to said first swing arm said attachment point;
said spanning bar said second end attached to said second swing arm said attachment point;
said first swing arm and said second swing arm attachable to said motorcycle frame outside with said frame pivot bolt passing through each said axis hole and said frame pivot axis.

2. The device of claim 1 further comprising:
each said swing arm having an axle end.

3. The device of claim 1 further comprising:
said first swing arm being a flared swing arm positioned on a frame belt side; and
said flared swing arm crossing a drive belt.

4. The device of claim 1 further comprising:
said first swing arm on a frame belt side; and
said axle end of said first swing arm attachable to an axle outside a tire and a wheel sprocket.

5. The device of claim 1 further comprising:
said first swing arm on a frame belt side; and
said axle end of said first swing arm attachable to an axle intermediate a tire and a wheel sprocket.

6. The device of claim 1 further comprising:
said first swing arm on a frame belt side; and
said first swing arm connected to said frame outside a drive belt.

7. The device of claim 1 further comprising:
said first swing arm on a frame belt side; and
said first swing arm connected to said frame inside a drive belt.

8. The device of claim 1 wherein:
said spanning bar spans a width of said frame.

9. The device of claim 1 wherein:
said first swing arm and said second swing arm having cut-outs.

10. A wide swing arm assembly for a motorcycle frame having a horizontal suspension system, a frame pivot axis and a frame span, said swing arm assembly comprising:
a first swing arm, a second swing arm, a spanning bar and a frame pivot bolt;
each said swing arm having a frame end;
at least one said swing arm having an axle end;
said first swing arm and said second swing arm each having an axis hole and a spanning bar attachment point at said frame end;
said spanning bar having a first end and a second end;
said spanning bar said first end attached to said first swing arm said attachment point;
said spanning bar said second end attached to said second swing arm said attachment point; and
said first swing arm axis hole and said second swing arm axis hole set apart a distance at least as great as said frame span.

11. The device of claim 10 further comprising:
said first swing arm being a flared swing arm positioned on a frame belt side; and
said flared swing arm crossing a drive belt.

12. The device of claim 10 further comprising:
said first swing arm on a frame belt side; and
said axle end of said first swing arm attachable to an axle outside a tire and a wheel sprocket.

13. The device of claim 10 further comprising:
said first swing arm on a frame belt side; and
said axle end of said first swing arm attachable to an axle intermediate a tire and a wheel sprocket.

14. The device of claim 10 further comprising:
said first swing arm on a frame belt side; and
said first swing arm connected to said frame outside a drive belt.

15. The device of claim 10 further comprising:
said first swing arm on a frame belt side; and
said first swing arm connected to said frame inside a drive belt.

16. The device of claim 10 wherein:
said spanning bar being as long as said frame span.

17. The device of claim 10 wherein:
said first swing arm and said second swing arm having cut-outs.

18. The method for modifying a motorcycle frame to accommodate a wide tire, said frame having a standard swing arm, a horizontal shock system, a frame pivot axis and a frame outside, said method comprising:
disconnecting said horizontal shock system from said standard swing arm;
removing said standard swing arm;
attaching a wide swing arm assembly to said frame outside, said wide swing arm assembly comprising two swing arms, a spanning bar and a frame pivot bolt, said two swing arms comprising a first swing arm and a second swing arm, said first swing arm and said second swing arm each having a frame end, each said frame end having an axis hole and a spanning bar attachment point, at least one said swing arm having an axle end, said spanning bar having a first end and a second end, said spanning bar said first end attached to said first swing arm said attachment point, said spanning bar said second end attached to said second swing arm said attachment point; and
connecting said horizontal shock system to said spanning bar.

19. The method of claim 18 wherein:
said first swing arm being a flared swing arm positioned on a frame belt side; and
said flared swing arm crossing a drive belt.

20. The device of claim 18 further comprising:
said first swing arm on a frame belt side; and
said axle end of said first swing arm attachable to an axle outside a tire and a wheel sprocket.

21. The device of claim 18 further comprising:
said first swing arm on a frame belt side; and
said axle end of said first swing arm attachable to an axle intermediate a tire and a wheel sprocket.

22. The device of claim 18 further comprising:
said first swing arm on a frame belt side; and
said first swing arm connected to said frame outside a drive belt.

23. The device of claim 18 further comprising:
said first swing arm on a frame belt side; and
said first swing arm connected to said frame inside a drive belt.

24. The method of claim 18 wherein:
said spanning bar spans a width of said frame.

25. The method of claim 18 wherein:
said first swing arm and said second swing arm having cut-outs.
